(19) United States
(12) Patent Application Publication
(10) Pub. No.: US 2004/0160054 A1
(43) Pub. Date: Aug. 19, 2004

(54) Combined collection or storage device for biological specimens

(76) Inventor: Brad Davin, Seneca, SC (US)

Correspondence Address: Brian D. Voyce, 8401 Sterling Bridge Road, Chapel Hill, NC, 27516, US

(21) Appl. No.: 10/368,312

(22) Filed: Feb. 13, 2003

(51) Int. Cl. B42D 15/00

(52) U.S. Cl. 283/74

(57) ABSTRACT

The present invention relates to a combined collection or storage device for a biological specimen. The device comprises an envelope having a storage pocket and a flap that can seal the envelope and a device having a biological specimen collection material attached to the envelope by a detaching means. A first identification means is disposed on the envelope that contains identifying information. A second identification means is disposed on the device that contains information that is identical to that of the first identification means. The device can be detached from the envelope and inserted into the storage pocket for transport or storage. An advantage of the present invention is that one can avoid the chance of information regarding a biological specimen being lost or mismatched.

### BACKGROUND OF THE INVENTION

(1) Field of the Invention

The present invention relates to a combined collection or storage device for a biological specimen. The device comprises an envelope having a storage pocket and a flap that can seal the envelope and a device having a biological specimen collection material attached to the envelope by a detaching means. A first identification means is disposed on the envelope that contains identifying information. A second identification means is disposed on the device that contains information that is identical to that of the first identification means. The device can be detached from the envelope and inserted intact into the storage pocket. An advantage of the present invention is that one can avoid the chance of information regarding a biological specimen being lost or mismatched.

(2) Description of the Related Art, Including Information Disclosed Under 37 CFR 1.97 & 1.98

U.S. Pat. No. 6,007,104 and related U.S. Pat. No. 6,152,493 to Draper disclose a combined medical device and form having a unitary substrate divided into a form portion and a device portion. Identification material, preferably identical and machine-readable, is present on both the form portion and the device portion. The Draper device comprises a one-piece substrate having a form portion and a device portion. Biographical data is included on a section on the form portion of the substrate. Form identification material is on the form portion while device identification material is on the device portion, such that one can match the two portions. A separation line divides the two portions, and thus separates the respective two identification materials.

### BRIEF SUMMARY OF THE INVENTION

An object of the present invention is to provide a secure and convenient means for collecting a biological specimen, while protecting the physical integrity of the collected specimen, protecting the integrity of matching identification information, and protecting the integrity of matching the specimen to the identification information, preferably including demographic information regarding the specimen.

Another object of the present invention is to allow a biological specimen to be linked to the collection material all the way through a testing procedure, particularly a forensic evidence process as used in a contemporary criminal justice system. By using the present invention, proper continuity protection is provided. Such protection remains even after the sample area is removed from the device for testing or storage.

The present invention encompasses a combined collection or storage device and form (10). As seen in the FIGURES, an envelope is provided that has a storage pocket and a flap (24) that can seal the envelope. A device having a biological specimen collection material (30) is attached to the envelope by a detaching means (32). A first identification means (40) is disposed on the envelope that contains identifying information. A second identification means (50) is disposed on the device that contains information that is identical to that of the first identification means. The device can be used to collect a biological specimen (such as DNA or blood). Upon collecting the specimen, one notes identifying information on one of the identification means, detaches the collection material from the envelope, inserts it into the storage pocket, and seals the envelope.

### BRIEF DESCRIPTION OF THE DRAWINGS

FIG. 1 is an exploded perspective view of a first preferred embodiment of the present invention before use and storage of a specimen.

FIG. 2 is a planar view of a preferred embodiment of the present invention prior to use with a safety flap in place.

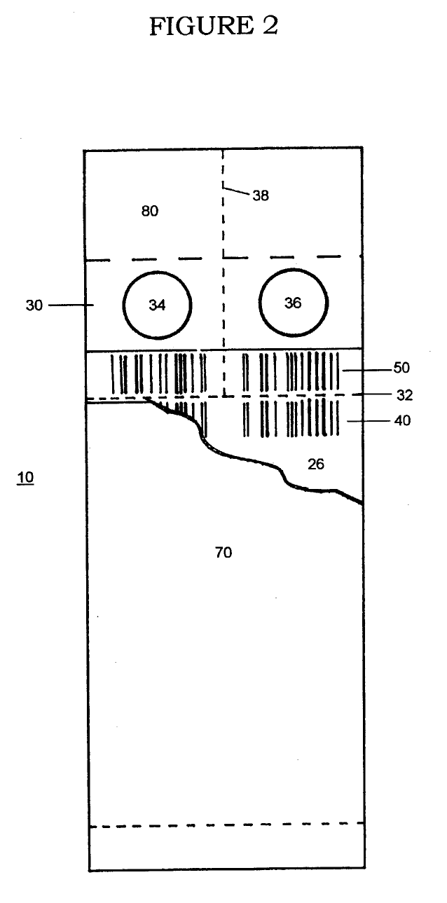

FIG. 3 is a planar view of a preferred embodiment of the present invention after use with a safety flap folded.

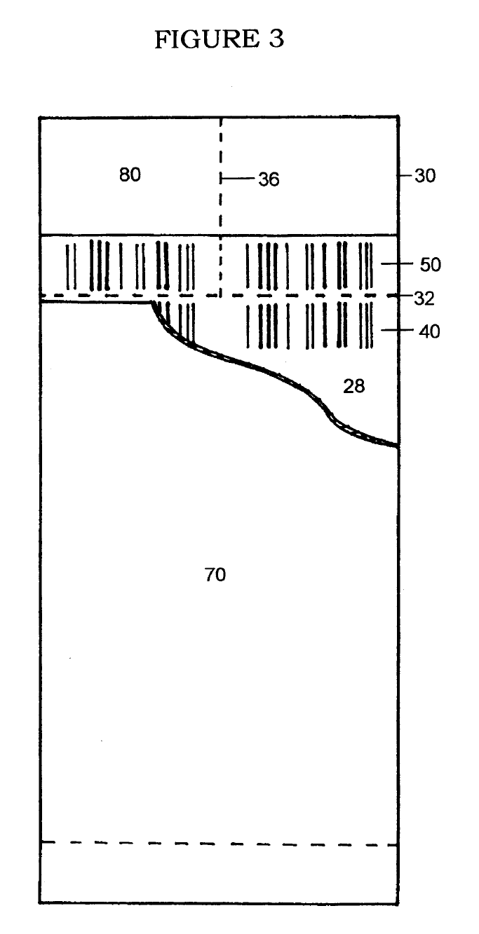

FIG. 4 is an exploded perspective view of a second preferred embodiment of the present invention before use and storage of a specimen.

FIG. 5 is a lateral view of the second preferred embodiment before use and storage of a specimen.

### DETAILED DESCRIPTION OF THE INVENTION

In preferred embodiments, the present invention relates to a combined biological specimen collection or storage device and form.

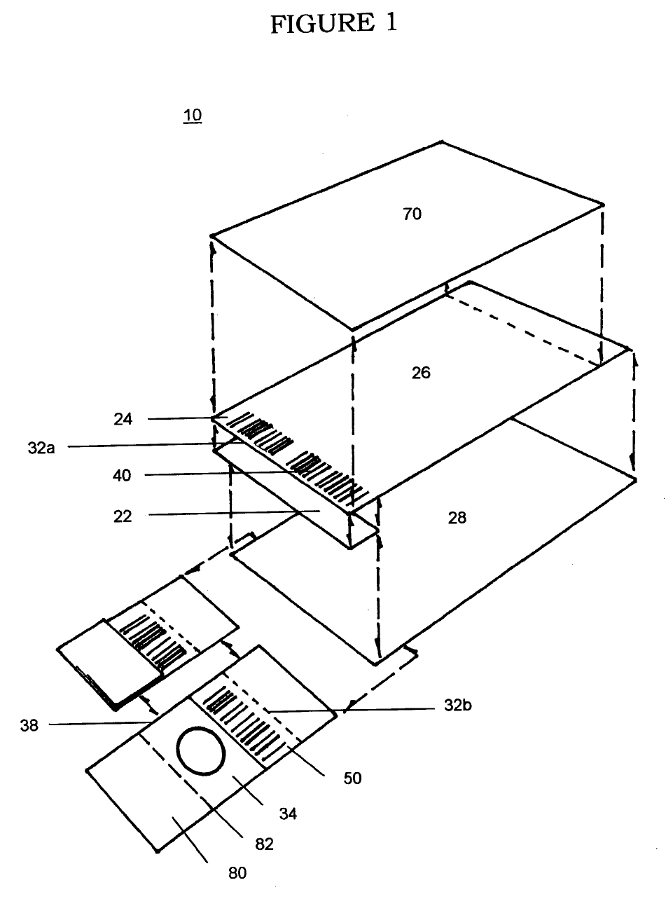

A combined device for collecting a biological specimen, such as DNA from buccal swabs for forensic evidentiary purposes, is shown in FIG. 1. In this embodiment, the combined device has an envelope or storage pocket that is open before use of the device. An envelope having a rectangular shape is formed from two planar surfaces such as two pieces (26 and 28) of planar card stock sealed together on three of the four edges, thereby forming a storage pocket. The card stock is not sealed on the fourth edge, forming an opening for the storage pocket.

A DNA specimen collection material (30), such as IsoCode® collection paper from Schleicher & Schuell, Inc. of Keene, N.H., USA, is adhered to the open edge of one of the pieces of card stock (in this illustration the lower stock (28)). Preferably, the IsoCode® paper has two sample collection areas (34 and 36) with a separation line (38) between the two areas. By such an arrangement, one can detach and test one of the sample collection areas while keeping the other sample collection area intact. To provide protection of the sample collection area from contamination, the card stock can be sized so as to be able to extend over and fold about the sample collection material along a safety fold line (82), forming a safety flap (80) that protects both collection areas.

To ease separation of the sample collection material from the envelope, a detaching means (32) such as a separation perforation line is provided on the lower card stocks ((32a) in the illustrations).

To prevent access to the storage pocket until detachment, one can preferably adhere the sample collection material to both card stocks. In such a case, the upper and lower card stocks are adhered not about the detaching means, but at a point distal to the detaching means. Thus, a tearing of the separation removes the fourth sealed edge of the two card stocks.

To allow for the envelope to be sealed, one can provide a flap (24) with a releasable film tape strip. The tape strip (22) is shown in FIG. 1, located across the pocket opening disposed on the upper card stock, between the IsoCode® paper separation means on the upper card stock (32a) and the separation line on the lower card stock (32b). The opening for the storage pocket can be maintained by not adhering the card stocks together about the separation means on the upper card stock (32a) and that on the lower card sock (32b).

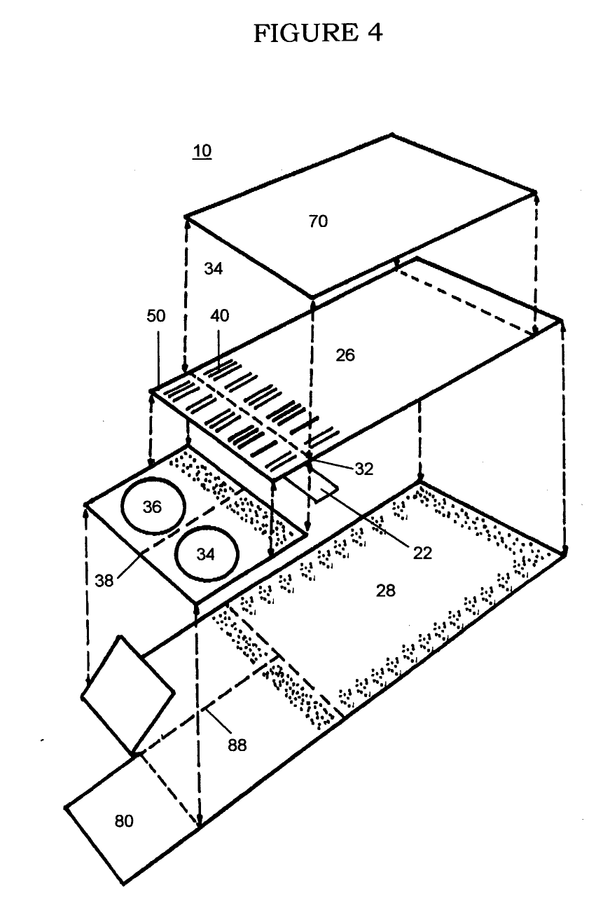

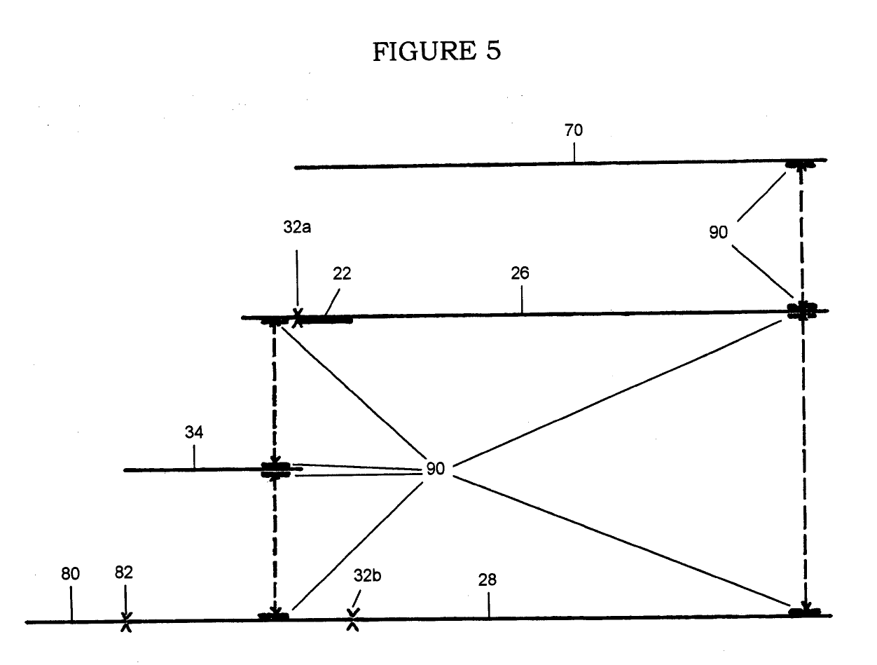

A second preferred embodiment is illustrated in FIGS. 4 and 5. The envelope is closed until the device is detached. The lower card stock (28) is dimensioned so as to form the safety flap (80). The lower card stock is provided with perforation line (88) that matches the perforation line (38) separating the two sample collection areas (34 and 36). Thus, one can use the safety flap to separate the areas without contacting the areas directly. Also, the first identification means (40) and the second identification means (50) are located so as to be extensions of each other on the upper card stock, thereby allowing printing of the identification means on one card stock before assembly. Finally, by applying a conventional adhesive about the periphery of the adjacent card stocks at the glue lines (90) shown in FIG. 5, one can form an envelope that is sealed prior to separation of the collection material, preventing contamination of the storage pocket. The envelope is opened by the removing the collection material along the separation lines (32a and 32b).

As shown in FIG. 4, one can employ a cover flap (70) attached to the exterior of the envelope that contains instructional information for use of the combined device and form. For redundancy, one can place a removable spare identification means on the cover flap for placement on either the device or the envelope in case of some damage to either the first identification means or the second identification means. The information on the removable spare identification means should be identical to that on the first identification means and the second identification means.

A split barcode can be used for providing identifying information for matching the demographic information section on one face of the envelope with the specimen collection material section after separation of the two for testing. The barcode combines a first identification means (40) disposed on the upper card stock with an adjacent second identification means (50) disposed on either the lower card stock or the collection material attached to the lower card stock. The demographic information section contains information for the individual from which a DNA sample has been collected such as their name, their signature, and a digit print from them.

Other preferred embodiments can provide for a desiccant pouch, such as a conventional silica gel, to be inserted in the storage pocket at the time the collection sample is inserted.

In operation, the user would read the instructions on the cover sheet and remove the cover sheet before completing the demographic information section. After completing filling in the information, the operator of the combined device would remove the specimen collection material section with the safety flap closed. Then, the safety flap can be opened sp as to expose the specimen collection paper for the collection of the biological specimen. The safety flap is closed after the collection process is completed. The entire specimen collection material section is inserted intact into the envelope, or depending on use, only one section can be inserted. Finally, the cover of the tape strip is removed, exposing the glue on the flap. Folding the flap seals the envelope.

The ordinarily skilled artisan can appreciate that the present invention can incorporate any number of the preferred features described above.

All publications or unpublished patent applications mentioned herein are hereby incorporated by reference thereto.

Other embodiments of the present invention are not presented here which are obvious to those of ordinary skill in the art, now or during the term of any patent issuing from this patent specification, and thus, are within the spirit and scope of the present invention.

1. A combined collection or storage device and form comprising:
a) An envelope having a storage pocket and a flap that can seal the envelope;
b) A device having a biological specimen collection material attached to the envelope by a detaching means;
c) A first identification means disposed on the envelope that contains identifying information; and
d) A second identification means disposed on the device that contains information that is identical to that of the first identification means;
whereby the device can be detached from the envelope and inserted into the storage pocket for transport or storage.

2. The combined device and form of claim 1 wherein the first identification means is on the sealing flap.

3. The combined device and form of claim 2 wherein the first identification means extends over both sides of the sealing flap such that it can be read from either side of the envelope when sealed.

4. The combined device and form of claim 1 wherein the detaching means connects the device to the sealing flap.

5. The combined device and form of claim 4 wherein the first identification means extends from the sealing flap onto the device, thereby forming the second identification means.

6. The combined device and form of claim 1 wherein the device also comprises a safety flap that can surround the attached biological specimen collection material.

7. The combined device and form of claim 1 also comprises a demographic section on the exterior of the envelope.

8. The combined device and form of claim 1 wherein the detaching means is a perforation line.

9. The combined device and form of claim 1 wherein the biological specimen collection material comprises the device.

10. The combined device and form of claim 1 wherein the envelope is formed from two planar surfaces sealed together along the periphery of adjacent surfaces so as to leave at least a portion of the periphery of the adjacent surfaces unsealed, thereby forming the storage pocket.

11. The combined device and form of claim 1 wherein the envelope is formed from two planar surfaces sealed together along the periphery of adjacent surfaces with the collection material inserted along a portion of the sealed adjacent periphery, wherein the detaching means comprises the planar materials each having a separation line that allows separation of the collection material from the envelope thereby forming an envelope opening.

12. The combined device and form of claim 11 wherein the separation lines are disposed on the sealed adjacent planar surfaces so as to form a flap that can seal the opening formed by removing the collection material.

13. The combined device and form of claim 1 also comprising a cover flap attached to the exterior of the envelope containing instructional information for use of the combined device and form.

14. The combined device and form of claim 11 wherein the cover flap also comprises a removable spare identification means that can be placed on either the device or the envelope and having information identical to that of the first and second identification means.

15. The combined device and form of claim 1 wherein the envelope or the device also comprises a removable spare identification means having information identical to that of the first identification means and the second identification means.
